(19) United States
(12) Patent Application Publication
(10) Pub. No.: US 2008/0099456 A1
(43) Pub. Date: May 1, 2008

(54) DISPENSING METHOD FOR VARIABLE LINE VOLUME

(76) Inventors: Robert A. Schwenke, Fowlerville, MI (US); Craig Orr, Windsor (CA)

Correspondence Address: EXATEC;C/O BRINKS HOFER GILSON & LIONE, P. O. BOX 10395, CHICAGO, IL, 60610, US

(21) Appl. No.: 11/923,328

(22) Filed: Oct. 24, 2007

Related U.S. Application Data
(60) Provisional application No. 60/862,906, filed on Oct. 25, 2006.

(51) Int. Cl. H05B 3/84; B67D 5/62

(52) U.S. Cl. 219/203; 222/146.2

(57) ABSTRACT

An apparatus and method for printing a conductive grid onto a plastic panel, and a resultant product. A nozzle is mounted to the end of an arm, and the nozzle is coupled to a source of conductive ink. A flow regulator, coupled to the ink source, regulates the flow rate of ink out of the nozzle and is controlled by a controller. The controller is further configured to apply an initial conductive trace onto a panel and to apply a subsequent conductive trace beside or onto the initial conductive trace to vary the volume of the grid line along a portion of its length.

### CROSS-REFERENCE TO RELATED APPLICATIONS

This application claims priority to U.S. Provisional Application Ser. No. 60/862,906 filed on Oct. 25, 2006, entitled “DISPENSING METHOD FOR VARIABLE LINE VOLUME”, the entire contents of which are incorporated herein by reference.

### BACKGROUND

1. Field of the Invention

This invention relates to an apparatus and method of printing a conductive heater grid on plastic or glass glazing panels. More particularly, it relates to the printing conductive heater grids on glazing panels used as backlights in motor vehicles.

2. Description of Related Art

Plastic materials, such as polycarbonate (PC) and polymethylmethyacrylate (PMMA), are currently being used in the manufacturing of numerous automotive parts and components, such as B-pillars, headlamps, and sunroofs. Automotive rear window (backlight) systems represent one application for these materials due to their many identified advantages, particularly in the areas of styling/design, weight savings, and safety/security. More specifically, plastic materials offer the automotive manufacturer the ability to reduce the complexity of the rear window assembly through the integration of functional components into the molded plastic system, as well as the ability to distinguish their vehicles by increasing overall design and shape complexity. Being lighter in weight than conventional glass backlight systems, their incorporation into the vehicle may facilitate both a lower center of gravity for the vehicle (and therefore better vehicle handling & safety) and improved fuel economy. Further, enhanced safety is realized, particularly in a roll-over accident because of a greater probability of the occupant or passenger being retained in the vehicle.

Although there are many advantages associated with implementing plastic windows, these windows are not without technical hurdles that must be addressed prior to wide-scale commercialization. Limitations relating to material properties include the stability of plastics during prolonged exposure to elevated temperatures and the limited ability of plastics to conduct heat. Regarding the latter, in order to be used as a backlight in a vehicle, the plastic material must be compatible with the use of a defroster or defogging system (hereafter just referred to as a “defroster”). For commercial acceptance, a plastic backlight must meet the performance criteria established for the defrosting or defogging of glass backlights.

The difference in material properties between glass and plastics becomes quite apparent when considering heat conduction. The thermal conductivity of glass (T_{c}=22.39×10⁻⁴ cal/cm-sec-° C.) is approximately 4 to 5 times greater than that exhibited by a typical plastic (e.g., T_{c} for polycarbonate=4.78×10⁻⁴ cal/cm-sec-° C.). Thus; a defroster designed to work effectively on a glass window may not necessarily be efficient at defrosting or defogging (hereafter just “defrosting” or “defrost”) a plastic Window. The lower thermal conductivity of the plastic may limit the dissipation of heat from the heater grid lines across the surface of the plastic window. Thus, at a similar power output, a heater grid on a glass window may defrost the entire viewing area, while the same heater grid on a plastic window may only defrost those portions of the viewing area that are close to the grid lines.

A second difference between glass and plastics that must be overcome is related to the electrical conductivity exhibited by a printed heater grid. The thermal stability of glass, as demonstrated by a relatively high softening temperature (e.g., T_{soften}>>1000° C.), allows for the sintering of a metallic paste on the surface of the glass window to yield a substantially inorganic frit or metallic wire. Since the softening temperature of glass is significantly greater than the glass transition temperature of a typical plastic resin (e.g., polycarbonate T_{g}=145° C.), a metallic paste cannot be sintered onto a plastic panel. Rather, it must be cured on the panel at a temperature lower than the T_{g} of the plastic resin.

A metallic paste typically consists of metallic particles dispersed in a polymeric resin that will bond to the surface of the plastic to which it is applied. The curing of the metallic paste provides a conductive polymer matrix having closely spaced metallic particles dispersed throughout a dielectric layer. The presence of the dielectric layer (e.g., polymer) between dispersed conductive particles leads to a reduction in the conductivity, or an increase in resistance, of the cured heater grid lines, as compared to dimensionally similar heater grid lines sintered onto a glass substrate. This difference in conductivity manifests itself in poor defrosting characteristics exhibited by the plastic window, as compared to the glass window.

With the above in mind, it is clear that controlling the quality of the heater grid printed onto the panel is important in maximizing the efficiency and effectiveness of any defroster used with that panel. Various parameters affect the quality of the printed heater grid including variances in the width, height (i.e. volume) and straightness of the grid lines. The more variances that exist in width and height, the greater the negative impact on the effectiveness of the defroster. This is a result of unequal resistances in various sections of the grid line and busbars resulting in unequal resistive heating in various sections of the defroster. With regard to straightness, this is mainly an aesthetic concern that becomes more of an issue because of the ability of plastic window assemblies to have greater design flexibility and curvature.

A defroster may be printed directly onto the inner or outer surface of a panel, or on the surface of a protective layer, using a conductive ink or paste and various methods known to those skilled in the art. Such methods include, but are not limited to, screen-printing, ink jet printing and automatic dispensing. Automatic dispensing includes techniques known to those skilled in the art of adhesive application, such as drip & drag, streaming, and simple flow dispensing. Slower speeds and higher flow for the ink or paste rates can result in wider and higher grid lines although with the possibility of reduced line quality. Conversely, higher speeds and slower flow rates can result in slimmer and lower grid lines. With screen printing in particular, the height of the grid line is not readily variable.

From the above, it is seen that there is a need for an apparatus and method that can effectively control the quality and consistency with which grid lines are printed onto a panel.

### SUMMARY OF THE INVENTION

In overcoming the enumerated drawbacks and other limitations of the related art, the present invention provides an apparatus for printing grid lines formed from a conductive ink onto a plastic substrate or panel. The apparatus includes a support bed adapted to support the panel and an articulatable arm positioned relative the support bed such that an end of the arm opposes a surface of the panel to be printed. A dispensing nozzle is carried by the arm and mounted at the end of the arm; the nozzle is coupled to a source of conductive ink and to a nozzle height actuator that mounts the nozzle to the arm. Finally, a flow regulator is coupled to the ink source and the nozzle whereby the flow rate of conductive ink out of the nozzle is regulated. The apparatus also includes a height sensor configured to output a height signal relative to the surface of the panel. A controller, coupled to the arm, the flow regulator, the nozzle height actuator and the height sensor, is configured to articulate the arm so as to move the nozzle in a predetermined pattern about the surface of the panel and dispense grid lines having a predetermined volume. The controller is also configured to retrace at least part of the pattern and vary the volume on the grid lines

The present invention also includes a method for printing a conductive trace on the plastic panel. The method includes locating a nozzle proximate to a surface of the panel; moving the nozzle relative to the surface; dispensing a conductive ink onto the surface to form a grid; and retracing at least a portion of the grid to vary a volume of grid lines forming the grid.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIGS. 1A, 1B, 1C and 1D are schematic sectional views of four alternative embodiments of a window assembly as might be formed utilizing the present invention;

FIG. 2 is a perspective view of an apparatus according to the present invention and including a robot arm traversing a dispensing head over a panel of a window assembly;

FIG. 3 is a partial front view of the robot arm and dispensing head over the panel; and

FIG. 4 is a close up, cross sectional view of a heater grid line disposed on the panel utilizing the present invention.

### DETAILED DESCRIPTION OF THE INVENTION

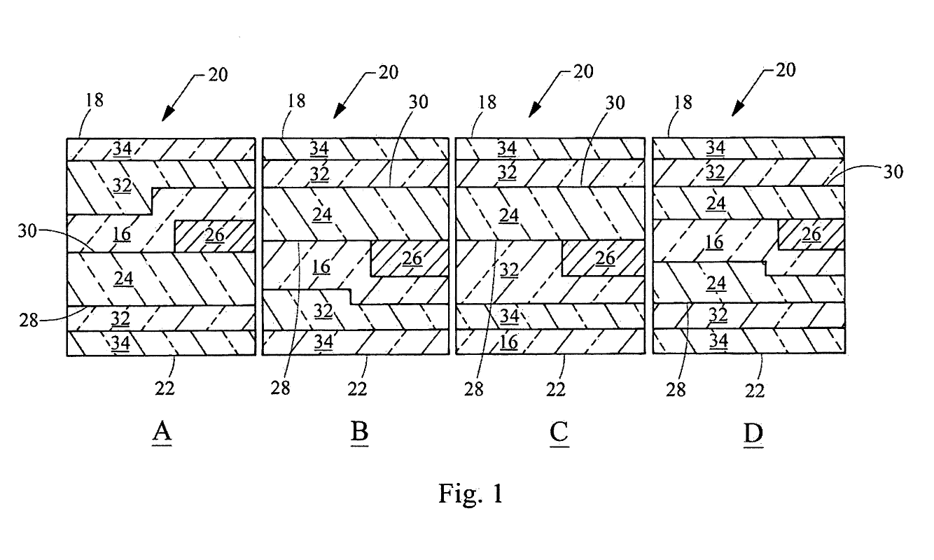

Referring now to FIG. 1, a cross-section of various examples of a plastic assembly 20 having a defroster or heater grid 16 is shown. The heater grid 16 may be positioned toward the external surface 18 of a plastic window assembly 20 (Example A), on an internal surface 22 of the plastic window assembly 20 (Example B and C), or encapsulated within the plastic panel (Example D) itself of the plastic window assembly 20. Each of the possible positions of the heater grid 16 in the example offers different benefits in relation to overall performance and cost of the window assembly 20. Positioning the heater grid 16 toward the external surface 18 (Example A) of the window assembly 20 is preferred so as to minimize the time necessary to defrost the window assembly 20. Positioning the heater grid 16 on the internal surface 22 (Example B and C) of a plastic panel 24 of the window assembly 20 offers benefits in terms of ease of application and lower manufacturing costs.

The transparent plastic substrate or panel 24 itself may be constructed of any thermoplastic polymeric resin or a mixture or combination thereof. Appropriate thermoplastic resins include, but are not limited to, polycarbonate resins, acrylic resins, polyarylate resins, polyester resins, and polysulfone resins, as well as copolymers and mixtures thereof. The panels 24 may be formed into a window through the use of any of the various known techniques, such as molding, thermoforming, or extrusion. The panels 24 may further include areas of opacity 26 applied by printing an opaque ink on the panel 24 in the form of a black-out border by molding a border using an opaque resin.

The heater grid 16 may be printed directly onto the inner surface 28 or outer surface 30 of the plastic panel 24. Alternatively, it may be printed on the surface of one or more protective layers 32, 34. In either construction, printing is affected using a conductive ink. The conductive ink may be modified with pigments, dyes, and/or fillers for aesthetic (color) and/or functional reasons (electrical conductivity). Common pigments may include: white pigments (e.g., titanium dioxide); yellow pigments, such as iron oxide yellow, chrome yellow, titanium yellow, diarylide yellow, monoarylide (monoazo) yellow, nickel azo yellow, vat yellow, and benzimidazolone yellow; red pigments, such as Iron oxide, toluidine red, naphthol red, quinacridone; blue and green pigments, such as iron blue, ferric ammonium ferrocyanide, copper phthalocyanine, phthalo blue, phthalo green; or black pigments, such as carbon black and acetylene black. Common dyes may include azo metal complexes in various colors. Common fillers may include: calcium carbonate, aluminum silicate (clay), magnesium silicate, silicon dioxide, and barium sulfate. A material with a positive temperature coefficient (PTC) may also be used as a filler. This filler would serve as a temperature regulating mechanism for the dispensed lines.

In its final construction, the plastic panel 24 may be protected from such natural occurrences as exposure to ultraviolet radiation, oxidation, and abrasion through the use of a single protective layer 32 on the exterior side of the panel 24 or additional, optional protective layers 34 on the interior side of the panel 24. As the term is used herein, a transparent plastic panel 24 with at least one protective layer 32 is defined as a “glazing”.

The protective layers 32, 34 may be a plastic film, an organic coating, an inorganic coating, or a mixture thereof. The plastic film may be of the same or different composition as the transparent panel. The film and coatings may comprise ultraviolet absorber (UVA) molecules, rheology control additives, such as dispersants, surfactants, and transparent fillers (e.g., silica, aluminum oxide, etc.) to enhance abrasion resistance, as well as other additives to modify optical, chemical, or physical properties. Examples of organic coatings include, but are not limited to, urethanes, epoxides, and acrylates and mixtures or blends thereof. Some examples of inorganic coatings include silicones, aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, silicon carbide, tantalum oxide, titanium oxide, tin oxide, indium tin oxide, yttrium oxide, zinc oxide, zinc selenide, zinc sulfide, zirconium oxide, zirconium titanate, or glass, and mixtures or blends thereof.

The protective coatings applied as protective layers 32, 34 may be applied by any suitable technique known to those skilled in the art. These techniques include deposition from reactive species, such as those employed in vacuum-assisted deposition processes, and atmospheric coating processes, such as those used to apply sol-gel coatings to substrates. Examples of vacuum-assisted deposition processes include but are not limited to plasma enhanced chemical vapor deposition, ion assisted plasma deposition, magnetron sputtering, electron beam evaporation, and ion beam sputtering. Examples of atmospheric coating processes include but are not limited to curtain coating, spray coating, spin coating, dip coating, and flow coating.

As an illustrative example, a polycarbonate panel 24 comprising the Exatec® 900 automotive window glazing system (Exatec®, LLC, Wixom, Mich.) with a printed defroster 16 generally corresponds to the embodiment of FIG. 1C. In this particular case, the transparent polycarbonate panel 24 is protected with a multilayer coating system (Exatec® SHP-9× or Exatec® SHX, (Exatec, LLC, Wixom, Mich.) and a deposited layer of a “glass-like” coating (SiOₓC_{y}H_{z}) that is then printed with a heater grid 16 on the exposed surface of the protective layer 34 intended to face the interior of the vehicle. As a further alternative construction, a heater grid 16 may be placed on top of a layer or layers of a protective coating or coatings 32, 34, and then over-coated with an additional layer or layers of a protective coating or coatings. For instance, a heater grid 16 may be placed on top of a silicone protective coating (e.g., AS4000 by GE Silicones) and subsequently over-coated with a “glass-like” film.

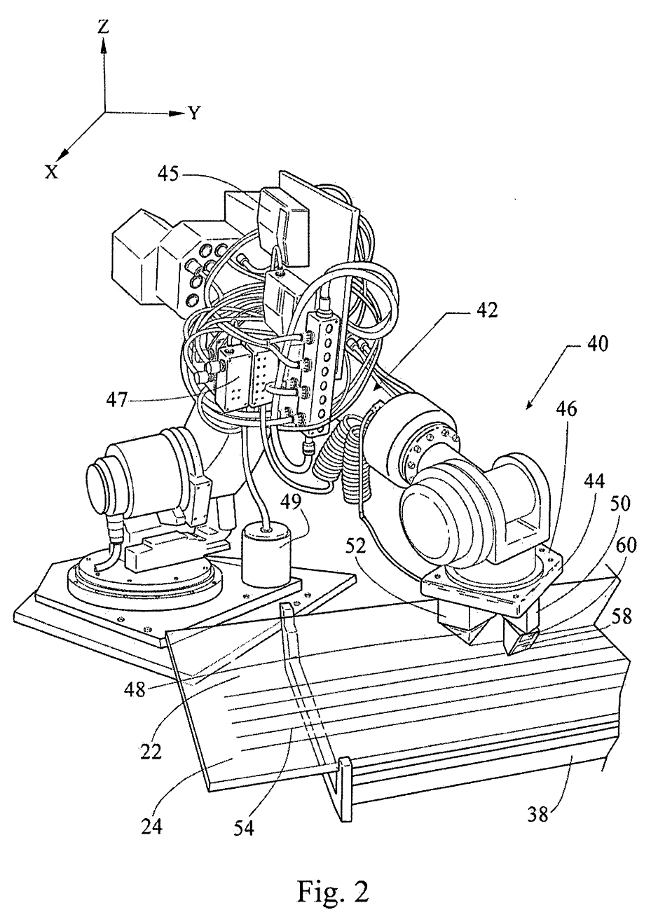

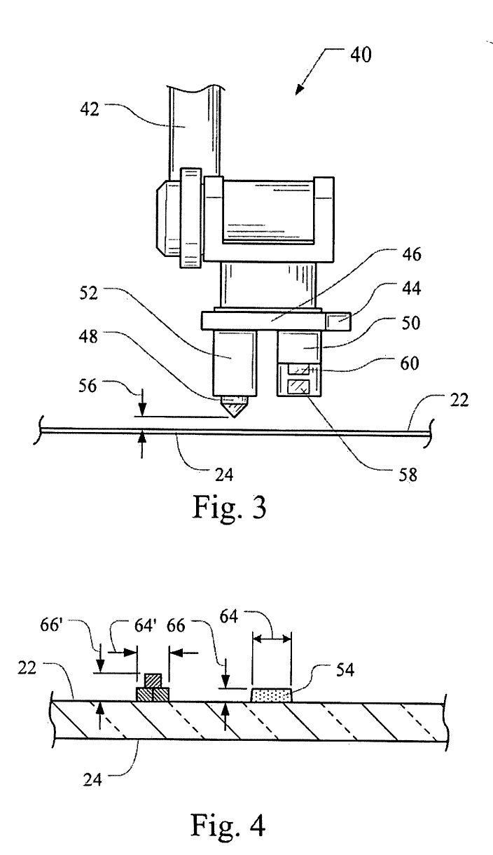

Turning now to the present invention, FIG. 2 illustrates one example of an apparatus 40, which may be a robotic arm or other device, for dispensing conductive ink upon the panel 24 (or glazing), resting on a support 38, to form a series of heater grid lines 54. The machine 40 includes a robot arm 42, mounted in a stationary manner to a support surface, and a dispensing head 44 attached to the end of the robot arm 42. A controller 45 is electrically coupled to the robot arm 42, the dispensing head 44 and a flow regulator 47 that is fluidly coupled to a conductive ink source 49. The robot arm 42 is articulatable and capable of moving the dispensing head 44 to any point on the surface 22 of the panel 24. Other examples of the machine 40 for dispensing a conductive material include those provided in U.S. patent application Ser. No. 11/321,567 filed on Dec. 29, 2005, which is herein incorporated by reference. The term dispensing utilized throughout the description of the invention presented here encompasses the various embodiments of the deposition method and apparatus described herein and in the aforementioned patent application. Alternatively, the dispensing head 44 may remain stationary while the support 38 is articulated to move relative to the dispensing head 44.

In a preferred operation, the robot arm 42 moves the dispensing head 44 in a linear direction across the panel 25 and the dispensing head dispenses the conductive ink from the source 49 onto the panel 25 in lines, forming the heater grid lines 54, only some of which are shown in FIG. 2 for clarity. While this is an exemplary embodiment, other examples may dispense the heater grid lines 54 in any other pattern, such as curves.

Looking more closely at the dispensing head 44, it is primarily composed of a base 46 supported by the robot arm 42. Coupled to the base 46 is a sensor 50 and an actuator 52, to which a nozzle 48 is mounted and further coupled to the conductive ink source 49 and flow regulator 47. The flow regulator 47 may be any device capable of controlling the flow rate of ink from the ink source 49 to the nozzle 48. During operation, by means of the flow regulator, the conductive ink is dispensed through the nozzle 48, onto the internal surface 22 of the panel 24. The flow regulator 47 may include, but not be limited to, a means of positively displacing the fluid, such as that known to occur via an auger, a piston, or a gear mechanism. To minimize weeping/drooling and excessive material buildup at printing starts and stops, the flow of material may be reversed by the flow regulator to “suckback” and prevent dispensing of excessive material. This may be accomplished in a variety of ways including reversing the rotation of the auger in a screw-type delivery system or applying vacuum to a pressure type delivery system.

To ensure the ink is dispensed in a manner to form the grid lines 54 of the desired width and height, the sensor 50, directly or indirectly, measures the distance of the dispensing head 48 from the surface 22 of the panel 24. As a result, the controller 45, while controlling the robot arm 42 to move the dispensing head 44 to a desired position over the surface 22, actively controls a z-axis position (height relative to the panel 24) of the nozzle 48 using the actuator 52 based on input from the sensor 50. The actuator 52 translates the position of the nozzle 48 to within a precise height 56 along the z-axis, (see FIG. 2), typically 0-3 mm or less, but more preferably between 0.51 mm, from the surface 22, depending on the desired characteristics of the grid lines 54. While the actuator 52 is a linear motor, alternative embodiments may use any electric, hydraulic, pneumatic, piezoelectric, electromagnetic, or other actuator 52 capable of similar precision and response time. Alternatively, the actuator 52 may be attached to the support 38 (not shown) to articulate the support 38 in the z-axis relative to the nozzle 48.

The sensor 50 is any sensor capable of measuring a height 56 from the surface 22 of the panel 24 and must be capable of measuring relative to a semi-reflective and/or transparent surface. While the exemplary sensor 50 is a laser triangulation sensor, any other non-contact sensor 50 could also be used, for example, a photonic sensor (i.e. measures the intensity of the reflected light), an air pressure sensor, an ultrasonic sensor, a magnetic sensor, or any other sensor. Additionally, contact sensors with appropriate means contacting the surface 22 in an appropriate manner (i.e. rolling contacts, sliding contacts, etc.) are also anticipated as being applicable with the present invention.

In the example shown, the sensor 50 comprises a triangulation laser arrangement made up of an emitter 58 and a receiver 60. To measure the distance of the nozzle 48 from the internal surface 22, laser light is projected from the emitter 58 and either directed or reflected onto the surface 22. The light is then reflected back to the receiver 60 and, based on the relative positions of the emitter 58 to the receiver 60, the sensor 50 calculates, by triangulation, the distance of the surface 22 from a reference point of the sensor 50. The height 56 is then calculated by the controller 45 based on the signal from the sensor 50 and a known position of the actuator 52 and the nozzle 48. As a result, the controller 45 may command the actuator 52 to raise or lower the nozzle 48 along the z-axis to compensate for variations in the surface of the panel 24 and maintain a predetermined height 56 above the surface 22. To increase the signal to noise ratio of this and other light based displacement sensors for height measurement, the surface of the fixture used to hold the partially transparent substrate panel may be coated with an anti-reflective coating such as flat black paint. Other anti-reflective methods may include surface texturing and/or baffling.

While the present embodiment compensates for variations in the z-axis, alternate embodiments may also compensate for variations in the x-axis and y-axis in order to keep the nozzle 48 normal to the surface 22 as it traverses the panel 24. Such an embodiment may be achieved using a plurality of sensor's 50 and actuator's 52 to manipulate the nozzle accordingly. In one embodiment, at least two additional sensor's 50 would measure the positions (x & y-axes) of the surface 22 to determine curvature in the panel. Based on inputs from these sensors, the controller 45 would command the robot arm 42 and/or additional actuator's to precisely rotate the nozzle 48 about the x-axis and y-axis, in addition to translating along the z-axis. As a result, the controller 45 may keep the nozzle 48 normal to the surface 22 at all times as it translates across the panel 24.

To reduce application errors due to part-to-part variability in the manufacturing process, the support 38 may be a precision substrate fixture with sufficient clamping strength and rigidity to deform the substrate into a predetermined shape. For example, a vacuum may be applied through a plurality of holes (not shown) in the support 38 to clamp the panel 24 to the support 38.

Those portions of the apparatus that come into contact with the conductive ink may be heated to a predetermined temperature to minimize the effect of temperature induced changes in the rheology of the ink. Preferably, this temperature would be high enough to encompass any fluctuations in room temperature yet not high enough to effect the ink in a negative way (i.e. degradation). For example, the panel 24, the nozzle 48, the flow regulator 47 and the source of conductive ink 49 may all be heated.

In order to achieve continuous, smooth motion along complex paths comprised of linear motion statements, approximate positioning of the dispensing apparatus and/or substrate is necessary. By specifying the percentage of the programmed velocity at which the approximate positioning begins, one can cause the articulation apparatus to move smoothly without the need to stop at each individual programmed location. This enhances the visual appearance of the dispensed feature while decreasing overall cycle time.

As a result, this arrangement allows for the precise control of the characteristics of the heater grid lines 54 by varying (increasing or decreasing) the height (h) 56 of the dispensing head 44 relative to the panel 24 and the flow rate (r) at which the ink is dispensed, based on the speed at which the dispensing head is being moved across the panel 24. Therefore, by precisely adjusting the height 56 of the nozzle 48 relative to the contour of the panel 24, and/or adjusting the flow rate of conductive ink from the nozzle 48, the apparatus 40 is able to dispense the ink in straight lines of having a width 64 and a height 66, resulting in a consistent volume unit (see FIG. 4) for the grid line 54. The height 66 and width 64, and hence the volume of the grid lines 54, can be varied to control the resistivity over the length or in a section of the grid lines 56. This is necessary in many applications to achieve a proper current density for thermal performance. It may be desirable to increase the volume of a grid line 54 to reduce the current density and alleviate a “hot spot” in a particular portion of the grid. In current automotive defroster designs, the grid lines may have a larger width near a busbar adjacent either end of the defroster and a taper to a smaller width in the center of the grid between busbars. With the present invention, a larger volume can be built near the busbars with a smaller volume near the center of the grid lines between the busbars

The volume can be varied by changing the width, the height and/or amount of conductive ink dispensed to make the grid lines. Changing the width and/or height of the traces requires dispensing the ink at a greater height, which may result in decreased line quality (i.e. waviness or meandering). Changing the volume by increasing or decreasing the amount of conductive ink dispensed is also problematic since adjusting the rate of ink delivery is difficult with current systems, often requiring hardware changes in the middle of dispensing the grid that require downtime and increase production costs.

However, the volume, via the width 64′ and height 66′, can also be changed by dispensing one initial set of gridlines having a minimum volume. This minimum volume may correspond to, for instance, the volume in the center of the automotive defroster grid. Thicker gridlines may be provided by retracing the initial grid lines and dispensing more material adjacent to and/or over the initial grid lines in areas where such material (additional volumes) is required (i.e. near the busbar of the automotive defroster grid). Where it is desired to maintain the initial volume of the grid lines, no additional material is dispensed in those areas during the retracing process. This permits variable line volumes with desirable aesthetic characteristics and without having to make hardware changes to the machine.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

1. An apparatus for printing a conductive ink onto a plastic panel, the apparatus comprising:
a support adapted to support the panel and a member positioned relative to the support such that an end of the member opposes a surface of the panel to be printed, the support and the member being articulatable relative to one another;
a nozzle carried by the member and mounted thereto at the end, the nozzle being coupled to a, source of the conductive ink;
a nozzle height actuator mounting the nozzle to the member;
a flow regulator coupled to the ink source and the nozzle, the flow rate of conductive ink out of the nozzle being regulated by the flow regulator;
a height sensor configured to output a height signal relative to the surface of the panel; and
a controller coupled to the arm, the flow regulator, the nozzle height actuator and the height sensor, the controller being configured to cause relative articulation of the member to the support so as to define a predetermined pattern about the surface of the panel with the nozzles, wherein the controller is configured to control at least one of the flow regulator and the nozzle height actuator as a function of at least one of the speed at which the nozzle is moved, the height signal from the height sensor and the flow rate of conductive ink out of the nozzle, and such that an initial conductive trace of predetermined volume is applied to the panel, and wherein the controller is further configured to retrace at least a portion of the conductive trace so as to vary the volume of a resultant conductive trace.

2. The apparatus according to claim 1 wherein the support of the panel is articulatable and the member carrying the nozzle is stationary.

3. The apparatus according to Claim 2 wherein the nozzle height actuator comprises a feedback mechanism that corrects the path that the articulated support follows.

4. The apparatus according to claim 1 wherein the nozzle height actuator comprises a feedback: mechanism that corrects the path that the member follows.

5. The apparatus according to claim 4 wherein the feedback mechanism corrects the path in real-time.

6. The apparatus according to claim 1 wherein nozzle height over the substrate is set according to articulation speed and dispensing rate.

7. The apparatus according to claim 1 wherein the support adapted to support the panel is coated with an anti-reflective coating, is surface textured, or is baffled.

8. The apparatus according to claim 7 wherein the anti-reflective coating is a flat black paint.

9. The apparatus according to claim 1 wherein the support adapted to support the panel is configured to deform the panel to a predetermined shape and to hold the panel in the shape.

10. The apparatus according to claim 9 wherein the support includes a vacuum source to hold the panel in position.

11. The apparatus according to claim 1 further comprising heating means for the nozzle, the flow regulator and the source of conductive ink to be heated to a predetermined temperature.

12. The apparatus according to claim 11 wherein the predetermined temperature is high enough to eliminate fluctuations in viscosity due to room temperature and low enough to avoid degradation of the conductive ink.

13. The apparatus according to claim 1 wherein the flow regulator is configured to allow for a negative or reverse flow in order to reduce weeping and drooling of the conductive ink when the ink is not being dispensed.

14. The apparatus according to claim 13 wherein the negative or reverse flow is created by reversing the rotation of an auger used in a screw-like delivery system.

15. The apparatus according to claim 13 wherein the negative or reverse flow is created by applying vacuum in a pressure-type delivery system.

16. The apparatus according to claim 1 wherein the controller is configured to retrace the initial conductive trace so as to apply a subsequent conductive trace adjacent to the initial conductive trace.

17. The apparatus according to claim 1 wherein the controller is configured to retrace the initial conductive trace so as to apply a subsequent conductive trace on the initial conductive trace.

18. The apparatus according to claim 1 wherein the controller is configured to retrace the initial conductive trace so as to apply a subsequent conductive trace beside the initial conductive trace on the panel.

19. A window defroster system comprising:
a window panel; and
a heater grid located on a surface of the window panel and formed of a conductive ink, the heater grid including a plurality of grid lines extending across at least a portion of the window panel, the grid lines including an initial conductive trace, at least some of the grid lines also including at least one subsequent conductive trace increasing the volume of the grid line along a portion of its length in order to optimize or normalize the amount of current through each grid line, the subsequent conductive trace being located adjacent to the initial conductive trace.

20. The heater grid according to claim 19 where the subsequent conductive trace is located beside the initial conductive trace on the window panel.

21. The heater grid according to claim 19 wherein the subsequent conductive trace is located on top of the initial conductive trace.

22. The heater grid according to claim 19 wherein a first subsequent conductive trace is located beside the initial conductive trace on the window panel and another subsequent conductive trace is located on top of at least a portion of the initial conductive trace.

23. A method for printing a conductive grid on a plastic panel comprising:
locating a nozzle proximate to a surface of a plastic panel having a surface to be printed upon;
moving the nozzle relative to the surface of the panel;
dispensing a conductive ink from the nozzle onto the surface of the panel to form a conductive grid formed of grid lines having a predetermined volume; and
retracing at least a portion of some of the grid lines to vary the volume of the grid lines along at least a portion of their length.

24. The method of claim 23 wherein the retracing step provides a subsequent conductive trace beside an initial conductive trace on the surface of the panel.

25. The method of claim 23 wherein the retracing step provides a subsequent conductive trace at least partially on top of an initial conductive trace.
